(19) United States
(12) Patent Application Publication
(10) Pub. No.: US 2026/0080455 A1
(43) Pub. Date: Mar. 19, 2026

(54) Bulk Order Placement and On Demand Fulfillment

(71) Applicant: Rebuy, Inc., Salt Lake City, UT (US)

(72) Inventor: John Robert Erck, Edina, MN (US)

(21) Appl. No.: 19/331,033

(22) Filed: Sep. 17, 2025

Related U.S. Application Data
(60) Provisional application No. 63/696,746, filed on Sep. 19, 2024.

(51) Int. Cl. G06Q 30/0601; G06F 9/54; G06Q 10/083

(52) U.S. Cl. CPC G06Q 30/0633; G06F 9/542; G06Q 10/083

(57) ABSTRACT

A bulk-on-demand (BOD) platform integrates with merchant e-commerce systems to let consumers buy bulk packages but redeem individual units later. A merchant configures a BOD definition, including a bulk product identifier, permissible product variants, total and minimum redemption quantities, and variant combination rules, via a user interface. The platform subscribes to order notifications from the merchant's e-commerce backend using an authorization token, detects BOD purchases, and credits a persistent vault associated with the buyer's account. The vault stores purchased and remaining quantities with a redemption history across multiple merchants. Customers redeem units through a customer-facing application; the platform validates requested quantities and variant selections, updates the vault, generates a structured fulfillment order including shipping information, and transmits the order for fulfillment. Notifications inform customers of updated balances and available options.

### CROSS REFERENCE TO RELATED APPLICATION

This application claims a benefit of, and priority to, U.S. Patent Application 63/696,746, filed Sep. 19, 2024, the contents of which is incorporated by reference in its entirety.

### TECHNICAL FIELD

This disclosure is related to data management and, more particularly, to methods and systems for configuring bulk on demand order placement on existing e-commerce platforms to enable buy in bulk and redeem on demand functionality for users.

### BACKGROUND

Network communications to enable e-commerce may require data communication of three distinct components for fulfillment, i.e., order information, payment information, and delivery information. It is technically challenging to decouple the three components because existing e-commerce network entities have their own requirements, protocols, formats and limitations. An organization looking to decouple the three components in a data transmission may not be equipped with the technical specialty to deliver network communications in an effective manner. The issue is particularly challenging if order fulfillment requires functionalities that are not operated by the organization.

### SUMMARY

In some embodiments, a bulk-on-demand platform bridges merchants'online stores and customers'on-demand purchasing needs. A merchant may log into a user interface of the platform and define a bulk-on-demand (“BOD”) product by selecting an existing product from their e-commerce catalog hosted on a separate e-commerce platform providing backend e-commerce functionality to the merchant's online store. The BOD definition may specify which product variants (e.g., sizes, flavors, styles; variants may be defined as additional separate existing products in the merchant's e-commerce catalog) may later be redeemed, and specify redemption rules such as the total quantity purchased, a minimum quantity that must be redeemed at once, and any permissible combinations of variants. Once configured, the BOD platform may automatically establish a secure subscription to an e-commerce backend of the merchant via an API (using a merchant-supplied authorization token). When a customer buys the BOD product on a website of the merchant via the e-commerce backend, the BOD platform may receive the order notification from the separate e-commerce backend associated with the merchant's website, recognize that it corresponds to the configured BOD product, map the customer identifier used by the e-commerce backend to a user account defined by the BOD platform, increment that user's persistent vault by the purchased quantity, and record the order event.

Each customer may have a persistent vault that tracks the total number of units purchased, the units remaining, and a history of prior redemptions. The platform may store both order events and redemption events alongside each vault record to enable accurate accounting and to enforce the redemption rules across multiple sessions and across different merchants' storefronts. The user interface presented by the customer-facing application of the BOD platform may show a unified vault, allowing users to view all of their BOD products from multiple merchants, see remaining units, and manage redemptions through a single interface. Whenever a vault is updated, such as after a new purchase, the platform may automatically send a notification (for example, a push notification, email, or SMS) to the user's device with the updated balance and the available variant options.

To redeem units, a customer may use the platform's client application or a merchant-hosted widget to submit a redemption request that includes the desired variants, the quantity to be redeemed, and a shipping address if needed. The platform validates that the requested quantity does not exceed the remaining balance in the vault, meets the merchant-defined minimum redemption quantity, and complies with any permitted variant combinations set by the merchant. If the request is valid, the platform may decrement the vault, generates a structured fulfilment order identifying the selected variants, quantity, pre-paid status, and shipping address, and transmit that fulfilment order as a structured data object to the merchant's e-commerce backend for processing and shipping.

In one or more embodiments, the above operations may be implemented as a computer-implemented method or as machine-executed instructions stored in memory and executed by one or more processors to enable merchants to sell bulk packages while giving consumers the flexibility to redeem individual units on demand.

### BRIEF DESCRIPTION OF THE DRAWINGS

The disclosed embodiments have other advantages and features which will be more readily apparent from the detailed description, the appended claims, and the accompanying figures (or drawings). A brief introduction of each figure (FIG) is below.

FIG. 1 illustrates an example system environment for a bulk on demand (BOD) platform, in accordance with one or more embodiments.

FIGS. 2A and 2B are sequence diagrams illustrating an example series of interactions among entities of the system environment to setup and redeem bulk on demand orders, in accordance with one or more embodiments.

FIG. 3 is an example illustration of graphical user interface provided by a bulk on demand platform for an application operator to compose a bulk on demand definition object, in accordance with one or more embodiments.

FIG. 4 is a flowchart depicting an example process for a bulk on demand platform to provide an interface for setup and redeem a bulk on demand order, in accordance with one or more embodiments.

FIG. 5 is a block diagram illustrating components of an example computing machine, in accordance with some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

This disclosure pertains to an online system that enables application operators to provide bulk-on-demand (BOD) services. Techniques disclosed herein look to implement a BOD platform that provides “buy in bulk” and “redeem on demand” technology to existing application operators. Conventionally, users of application operators buy “one-time” products on demand or “subscribe and save” to have an endless stream of “one-time” products shipped to them on a fixed scheduled until canceled. According to the present disclosure, a user may be able to buy now and save while also being able to redeem on-demand later in one or more installments. The BOD concept enables economies of scale and while increasing utility for users by not having to take delivery immediately of all the product purchased. The BOD configuration enables product abstraction by enabling users to make selections for product options (e.g., flavor, size, color, and the like) post purchase in an on-demand manner. The system decouples a product purchase step (e.g., buy a 10-pack) from a product selection and fulfillment step (e.g., redeeming 2 units of chocolate and/or vanilla flavor of the product, and the like). The BOD concept also enables user to select from their BOD inventory in the cloud system on demand according to their usage behavior rather than a fixed schedule. For the application operator, the BOD concept gives concrete insight into future demand which enables improved forecasting and demand planning, leading to processing efficiency and increased cost savings. The online system also provides users with a unified online vault and redemption experience for BOD purchased products from different application operators. The user can simply interact with an application of the online system to redeem on-demand selected quantities of BOD products. The online system is configured to orchestrate transaction interactions with associated application operators for order fulfillment without any further user input, thereby simplifying and streamlining the online experience for the user.

### Example System Environment

Referring now to Figure (FIG.) 1, shown is a block diagram illustrating an embodiment of an example system environment 100 for configuring and redeeming BOD products, in accordance with some embodiments. By way of example, the system environment 100 includes a BOD platform 110, application operators 120, an application builder platform 130, user computing devices 140, and a transaction fulfillment operator 150. The user computing devices 140 may be collectively referred to by the reference number 140 or individually as 140A, . . . , 140N (N being an nth device, n being some number). The entities and components in the system environment 100 may communicate with each other through networks 160.

In various embodiments, the system environment 100 may include fewer or additional components. The system environment 100 also may include different components. Also, while some of the components in the system environment 100 may sometimes be described in a singular form, the system environment 100 may include one or more of each of the components. For example, there may be multiple application operators 120 and multiple user computing devices 140. Various application operators 120 may be independent entities such as different enterprise customers of the BOD platform 110, which serves as a platform provider that manages BOD orders and associated actions on behalf of the application operators 120. Also, while the terms such as “server” and “operator” is used in the singular form, those terms may each include multiple instances that cooperatively or collectively perform certain functions or processes described in this disclosure. For example, a “server” may include a group of server computing systems that are operated under a single entity or multiple entities under contract to provide various services. Each server in the group may perform a different function.

In the system environment 100, various components may be operated by the same organization or different organizations. For example, in some embodiments, the message management platform 110, the application operator 120, the application builder platform 130, and the transaction fulfillment operation 150 are each operated by a different business. In one or more embodiments, two or more components may be operated by the same organization. For example, the organization that controls the application builder platform 130 may also be the transaction fulfillment operator 150.

The BOD operator 110 may include one or more computing servers that perform various tasks related to creating, setting up, managing, redeeming, and hosting BOD orders on behalf of application operators 120. The BOD platform 110 may refer to the party that operates the BOD platform 110. The actions related to the functionality provided by the BOD platform 110 may be enabled by providing users (e.g., application operators 120, merchants) with a frontend software application (e.g., BOD merchant application 145 running on user computing devices 140) for creating merchant accounts for setting up BOD products and BOD definition objects, and configuring the BOD platform to communicate with and receive data from the application builder platform 130 on behalf of the application operators 120.

The actions related to the functionality provided by the BOD platform 110 may be further enabled by providing users (e.g., customers of the application operators 120, end users) with a frontend software application (e.g., customer-facing application, BOD user application 143, widget installed in the frontend software (e.g., webpage, mobile app 142) of the application operator 120) to create end user accounts for maintaining a secure online vault (e.g., pantry in the cloud) of their BOD product purchases from one or more application operators 120, and to redeem their BOD product purchases from any application operator 120 on an on-demand, as needed basis, e.g., by triggering application-programming-interface (API) calls to the application builder platform 130 or to the transaction fulfillment operator 150 on behalf of the application operator 120 associated with the BOD product to instruct the application builder platform 130 or the transaction fulfillment operator 150 to fulfill redemption requests received by the BOD platform 110.

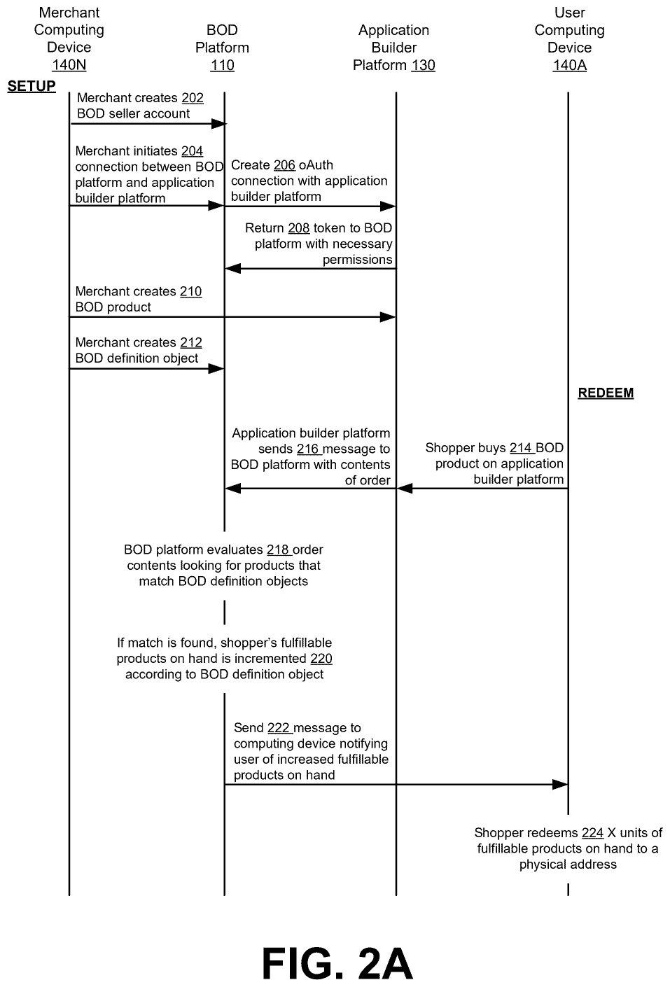

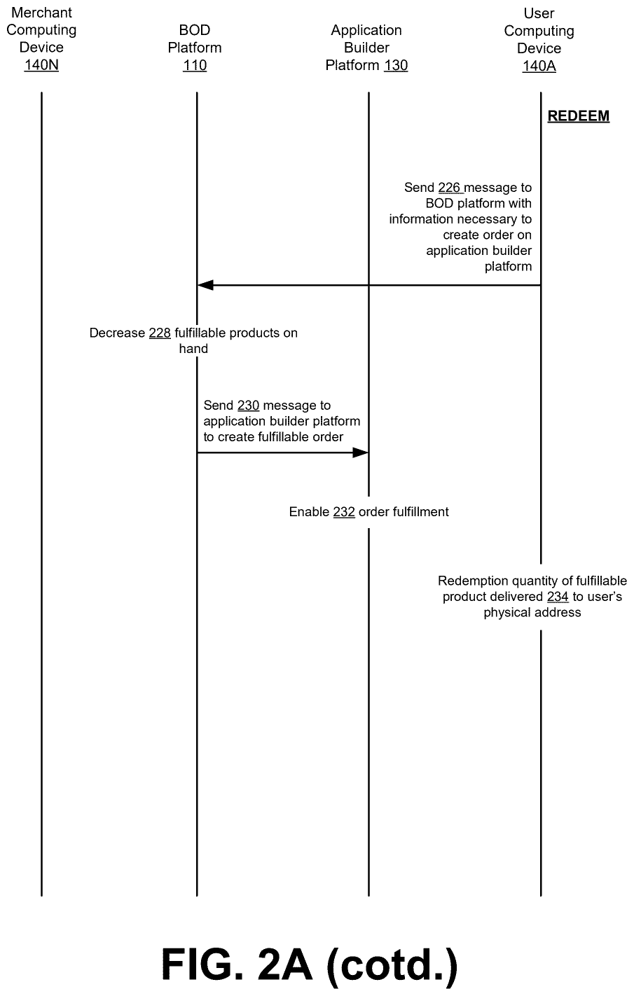

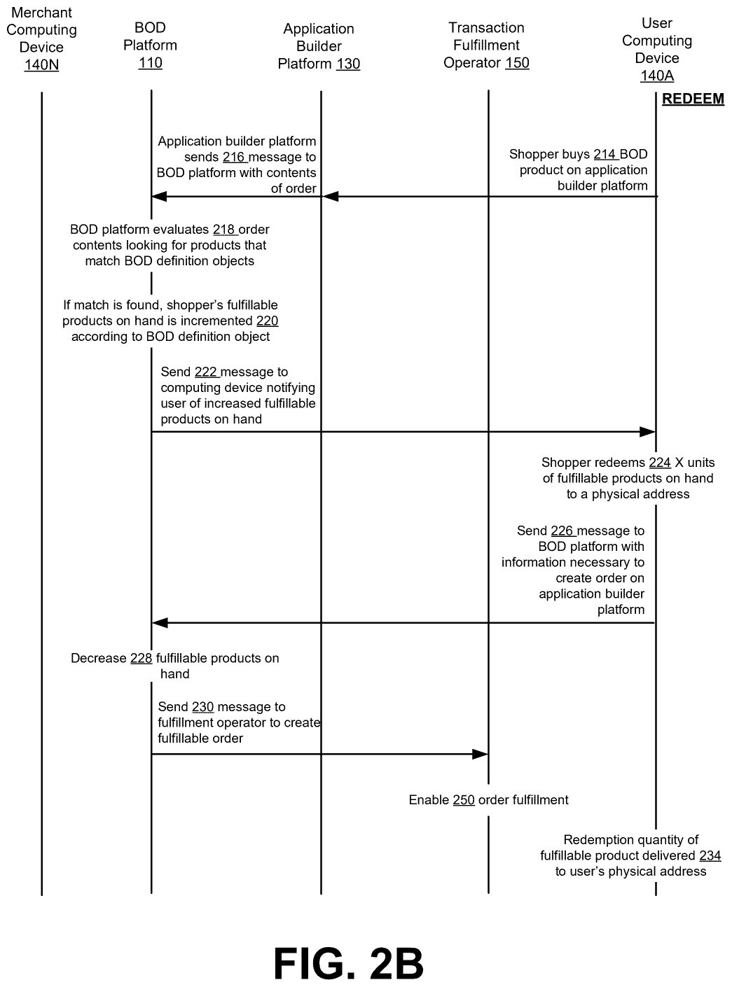

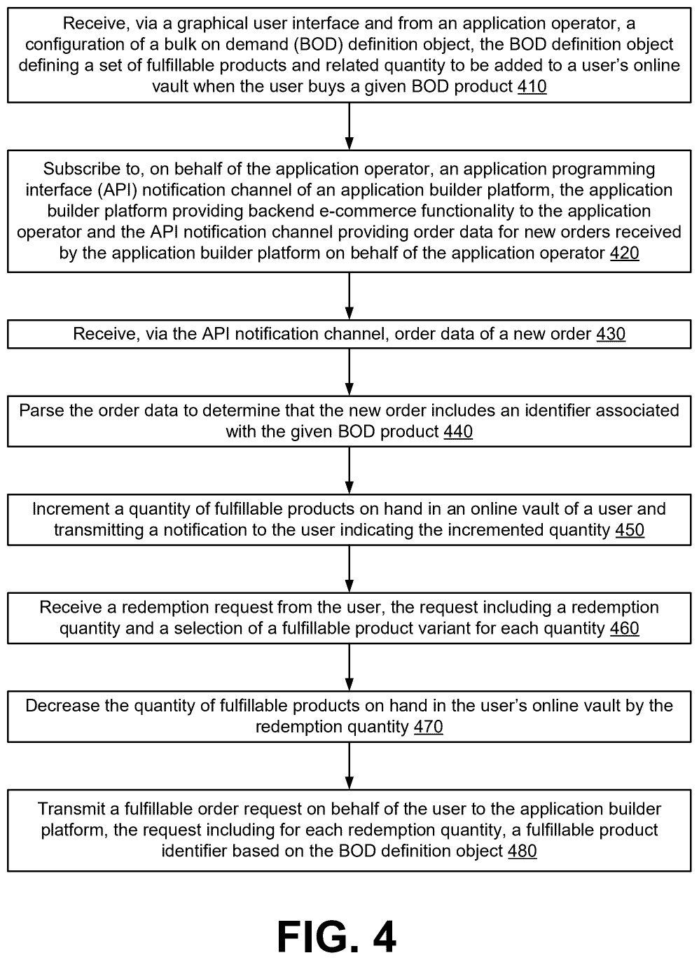

The BOD platform 110 may be operated by an entity that uses a combination of hardware and software to build and operate the platform. A computing server used by the BOD platform 110 may include some or all example components of a computing machine described in FIG. 4. The BOD platform 110 may include a computing server that takes different forms. In one or more embodiments, the BOD platform 110 may be a server computer that executes code instructions to perform various processes described herein. In one or more embodiments, the BOD platform 110 may be a pool of computing devices that may be located at the same geographical location (e.g., a server room) or be distributed geographically (e.g., clouding computing, distributed computing, or in a virtual server network). In one or more embodiments, the BOD platform 110 may be a collection of servers that cooperatively provide BOD services as described herein. The BOD platform 110 may also include one or more virtualization instances such as a container, a virtual machine, a virtual private server, a virtual kernel, or another suitable virtualization instance. The BOD platform 110 may provide application operators 120 or other organizations (e.g., retail or commerce operators) with various BOD services as a form of cloud-based software, such as software as a service (SaaS), through the network 160. Functionality of the BOD platform 110 may be accessible to merchants and end users by operating applications 143 and 144 deployed on user computing devices 140. Examples of components and functionalities of the BOD platform 110 are discussed in further detail below with reference to FIGS. 2A-2B, 3, and 4.

Application operators 120 (e.g., merchant operators) are entities that control software applications 142 that are used by user computing devices 140. For example, an application operator 120 can be an application publisher that publishes mobile applications available through application stores (e.g., APPLE APP STORE, ANDROID STORE). In some cases, the application may take the form of a website and the application operator 120 is the website owner. In one or more embodiments, the application operators 120 are businesses that provide goods and/or services to end users who possess the user computing devices 140. In one or more embodiments, an application operator 120 sells products through an application 142 and may be referred to as a merchant. In the system environment 100, the application operators 120 may be the customers of the BOD platform 110 and the customers of the application builder platform 130.

An application operator 120 may delegate certain operations, such as management of setup, redemption and fulfillment of BOD products, to the BOD platform 110. For example, the application operator 120 may use the BOD merchant application 144 of the BOD platform 110 to configure BOD products and BOD definition objects, and provide the necessary permissions (e.g., tokens 145) to the BOD platform 110 to enable the BOD platform 110 to receive data from the application builder platform 130 on behalf of the application operator 120. The application operator 120, through functionality provided by the BOD platform 110, may sell a BOD product (e.g., a 10-pack) that may be delivered to the user on-demand and on an as needed basis, one or more units at a time.

By way of example, an application operator 120 may be a retail business that operates an electronic retail platform in an application 142 and uses the service of the BOD platform 110 to sell BOD products. In another example, another retail business (e.g., fast food chain) may use the BOD platform 110 to secure a very large order. The BOD platform 110 may create and offer to end users BOD products that may be redeemable on-demand at one or more retail locations of the retail business (e.g., a 10-pack order of cheeseburgers redeemable at any location of a burger fast food chain). These are non-exhaustive examples of application operators 120. Various application operators 120 may be independent and unrelated entities, such as different unrelated businesses.

An application builder platform 130 (e.g., e-commerce platform) may include one or more computing servers that perform various tasks related to assisting application operators 120 to build applications 142, providing ready-to-use functionalities to those applications 142, operating a digital distribution platform that provides a selection of third-party functionalities that can be integrated into applications 142, providing back-end functionalities for applications 142, and/or performing actions such as fulfillment for transactions that are completed through applications 142. The application builder platform 130 may also provide backend functionality to enable BOD order management by the BOD platform 110. For example, the application builder platform 130 may transmit to the BOD platform 110, order data (e.g., new order received) of an application operator 120 that has configured the appropriate settings for transmission of such data to the BOD platform 110. The application builder platform 130 further perform fulfillment of redemption transactions that are completed through the BOD user application 143 or the widget of the BOD platform 110 installed in the application 142 for application operators 120 who have configured the appropriate settings for BOD product order fulfillment through the application builder platform 130.

The application builder platform 130 may refer to the party that operates the application builder platform 130. By way of example, the application builder platform 130 may be an e-commerce platform, such as SHOPIFY, that allows application operators 120 to build an application 142, which may take the form of a mobile application, a website, or a software program, on the platform of the application builder platform 130. The application builder platform 130 may also be referred to as an e-commerce platform, a backend shopping cart platform, or a website builder platform. The application 142 built using the platform may automatically incorporate certain standard features provided by the application builder platform 130, such as the checkout feature, shopping cart, payment management, and inventory management features provided by the application builder platform 130. Hence, the application operator 120 may design, for example, a website using the platform 130 and the website will automatically have e-commerce features.

With respect to the relationship between the application operator 120 and the application builder platform 130, while the application operator 120 is the operator of an application 142, the application operator 120 may not need to run the application in terms of the application's day-to-day software and hardware operations. The application operator 120 may control the application 142 in the business sense, such as being the owner of the application 142. For example, a retail merchant application operator 120 may own its retail website or retail mobile application. However, an application operator 120 may delegate the application's day-to-day software and hardware operations to the application builder platform 130. As such, in one or more embodiments, an application operator 120 may also be referred to as an application owner, an application publisher, a business, a service provider, and/or a merchant. In one or more embodiments, the application operator 120 may run some part of the day-to-day software and hardware operations of its application 142 while the application builder platform 130 provides support and additional features (e.g., e-commerce capability, backend data processing, and/or platform computer resources) to the application 142. For example, functionality related to BOD order placement and management may be integrated as a widget into the application 142 and such functionality may be provided by the BOD platform 110.

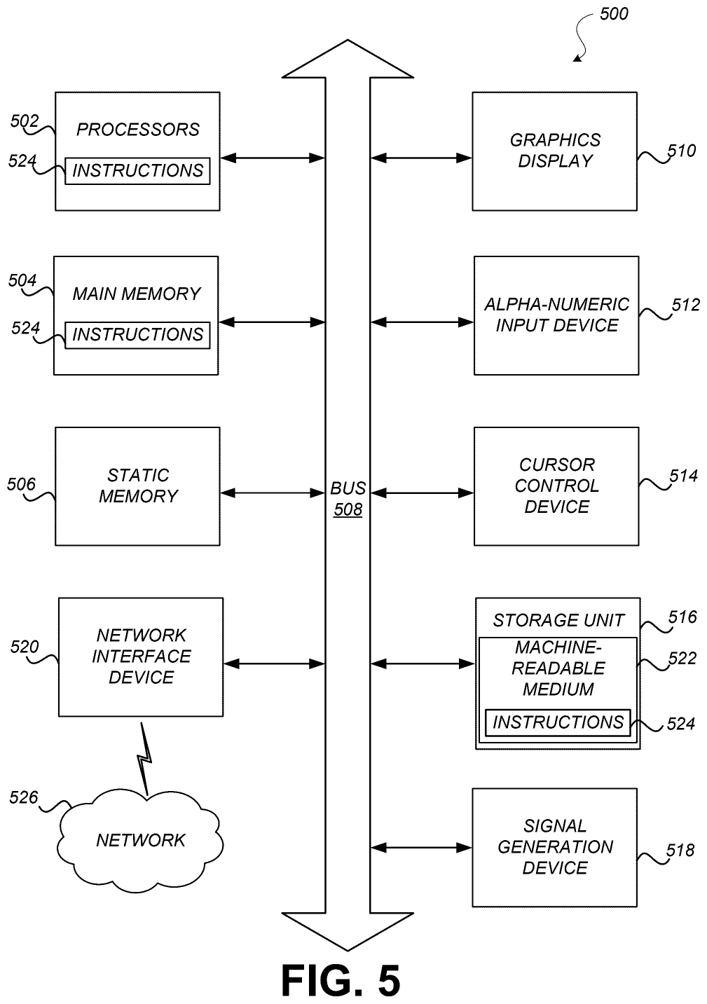

The application builder platform 130 may be operated by an entity that uses a combination of hardware and software to build and operate the platform. The application builder platform 130 may include some or all example components of a computing machine described in FIG. 5. The application builder platform 130 may sometimes be referred to as a website builder server, an e-commerce platform, an online-store building platform, or simply a computing server. The application builder platform 130 may include a computing server that takes different forms. In one or more embodiments, the application builder platform 130 may be a server computer that executes code instructions to perform various processes described herein. In one or more embodiments, the application builder platform 130 may be a pool of computing devices that may be located at the same geographical location (e.g., a server room) or be distributed geographically (e.g., clouding computing, distributed computing, or in a virtual server network). In one or more embodiments, the application builder platform 130 may be a collection of servers. The application builder platform 130 may also include one or more virtualization instances such as a container, a virtual machine, a virtual private server, a virtual kernel, or another suitable virtualization instance.

A user computing device 140 is a computing device that is possessed by an end user who may be the application operator 120 (e.g., the merchant; device 140N) or may be a customer of the application operator (e.g., end user; device 140A). For example, the user may be a merchant or agent of the merchant (i.e., application operator 120) who uses the computing device 140N to configure settings to enable secure data communication on behalf of the application operator 120 and between the BOD platform 110 and the application builder platform 130 and/or the transaction fulfillment operator 150. The computing device 140 may include a BOD merchant application 144. The application 144, which may take the form of a mobile application, a website, or a software program, enables the merchant user to, e.g., setup a merchant account on the BOD platform 110, create and launch BOD products, configure BOD definition objects, and configure settings (e.g., by setting a token 145 received from the platform 130) to subscribe to one or more channels of data (e.g., new order data channel) from the application builder platform 130 that is associated with the application operator 120. In one or more embodiments, the application builder platform 130 may provide the merchant a token 145 (e.g., secure authentication key, API key) that may be used by the BOD merchant application 144 to enable the BOD platform 110 to receive data on subscribed channels (e.g., new orders for the application operator 120 that are received by the application builder platform).

As another example, the user may be an end user (i.e., customer of the application operator 120) who uses the computing device 140A to configure and manage their secure vault of BOD products. The computing device 140 may include a BOD user application 143. The application 143, which may take the form of a mobile application, a website, or a software program, may provide various features to the end user to, e.g., setup a user account on the BOD platform 110, access the user's BOD product vault, redeem products, specify product options (e.g., variant, size, color, flavor, etc.) for redeemed products, buy new BOD products, refill BOD products, purchase new BOD products, and the like. An end user may receive messages from the BOD platform 110 that are related to an order placed by the end user with an application operator 120, e.g., via the application 142. In response to the user interacting with the received message (e.g., clicking a link in an email, or text/SMS message), the user may be routed to download and install the application 143 of the BOD platform 110. The application 143 may provide backend functionality to push the redeemed product details as a new customer order into the fulfillment workflow of the application builder platform 130.

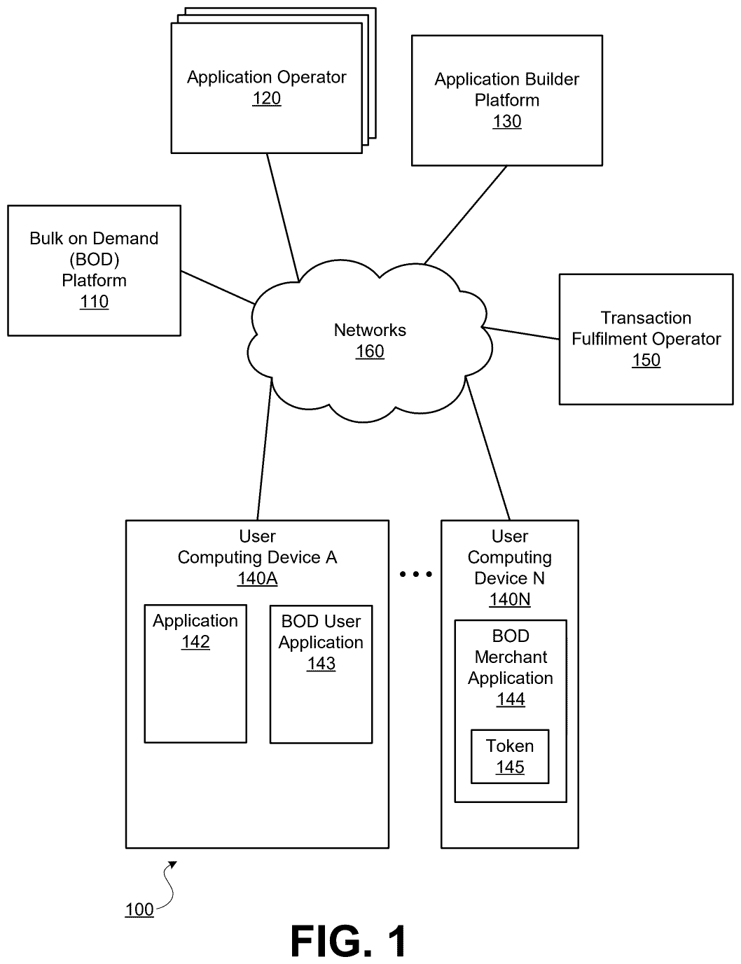

As shown in FIG. 1, the user computing device 140 may also include the application 142 deployed by the application operator 120. An end user may perform transactions, such as purchases, or service arrangements, with the application operator 120 through the application 142 that is operated by the application operator 120 with some features that may be provided or supported by the BOD platform 110 and by the application builder platform 130. For example, at least some of the features of the BOD user application 143 may be incorporated into the application 142, thereby providing the user a more seamless experience where they can purchase and consume BOD products from the same interface where the original product was purchased. In this case, the backend functionality for the BOD concept is still handled by the BOD platform 110.

Examples of user computing devices 140 include personal computers (PC), desktop computers, laptop computers, tablets (e.g., iPADs), smartphones, wearable electronic devices such as smartwatches, smart home appliances (e.g., smart home hubs and controllers), vehicle computer systems, or any other suitable electronic devices. The user computing devices 140 may run one or more applications 142 that are developed by various application operators 120 using the application builder platform 130. For example, the user may download various mobile apps and visit different websites that are operated by various businesses. Each instance of the mobile app and website may be an example of an application 142. Each application 142 may be developed by different creators. For example, in some embodiments, a first application 142 is developed by a first application operator 120 and a second application 142 is developed by a second application operator 120. Also, the user computing devices 140 may also run the BOD applications 143 and/or 144 as explained above.

Various applications 142, 143, 144, may take different forms. For example, some applications may take the form of webpages that have backend functionalities built using JAVASCRIPT, RUBY ON RAILS, etc. Other applications may be web applications that may appear as SaaS platforms. Yet other applications may be mobile apps that may run on Swift for iOS and other APPLE operating systems or on Java or another suitable language for ANDROID systems. In another case, an application may be a software program that operates on a desktop computer that runs on an operating system such as LINUX, MICROSOFT WINDOWS, MAC OS, or CHROME OS.

The transaction fulfillment operator 150 may be an entity that completes a transaction between an end user and an application operator 120. For example, an end user may redeem a BOD product through the application 143 of the BOD platform 110 which is communicatively coupled to the e-commerce backend provided by the application builder platform 130. After the confirmation of the purchase, e.g., based on an API notification received from the BOD platform 110, the application builder platform 130 (or the application operator 120) may transmit the detail to the transaction fulfillment operator 150 to carry out the transaction, which may include packaging and shipment. The transaction fulfillment operator 150 may provide notifications to the application builder platform 130 regarding various stages of status updates of the purchase, such as the shipment of the parcel, the delivery of the parcel, etc. In one or more embodiments, functionality of the transaction fulfillment operator 150 may be provided by the application builder platform 130.

The networks 160 provide connections to the components of the system environment 100 through one or more sub-networks, which may include any combination of the local area and/or wide area networks, using both wired and/or wireless communication systems. In some embodiments, the networks 160 use standard communications technologies and/or protocols. For example, a network 160 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 160 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 160 may be represented using any suitable format, such as hypertext markup language (HTML), extensible markup language (XML), JavaScript object notation (JSON), structured query language (SQL). In some embodiments, all or some of the communication links of a network 160 may be encrypted using any suitable technique or techniques such as secure sockets layer (SSL), transport layer security (TLS), virtual private networks (VPNs), Internet Protocol security (IPsec), etc. The networks 160 also include links and packet switching networks such as the Internet.

### Example Data Orchestration for the BOD Platform

FIGS. 2A and 2B are sequence diagrams illustrating an example series of interactions among entities of the system environment of the BOD platform 110, in accordance with one or more embodiments. The series 200 illustrated in FIGS. 2A and 2B represents specific sets of instructions that may be stored in one or more computer-readable media, such as memory of different servers. The instructions, when executed by one or more processors of the depicted entities, cause one or more processors to perform the described interactions. As depicted in FIGS. 2A and 2B, the series 200 is performed by a client device 140N controlled by an application operator 120, the BOD platform 110, the application builder platform 130, and a client device 140A controlled by an end user of the application operator 120. The series 200 depicts both the interactions for the setup phase of the BOD product and the redeem phase. The sequence of interactions 200 depicted in FIGS. 2A and 2B is merely an example of sequence of interactions, and in other embodiments the sequence of interactions may include fewer, additional, or different actions performed by the same or different entities. While the steps in series 200 are illustrated graphically in FIGS. 2A and 2B as sequences of steps, some of the steps may occur in different sequences than illustrated or may occur concurrently with other steps. Also, while series 200 is depicted as a single series, in various embodiments and situations the series 200 may be further broken down into multiple series 200.

FIG. 2A illustrates an example series 200A of interactions in which the application builder platform 130 also performs functionality of the transaction fulfillment operator 150. In the series 200A, the merchant operating the client device 140N may interact with the BOD merchant application 144 running on the client device 140N to create a BOD seller account. For example, the merchant may be an application operator 120 that already has an e-commerce storefront and now decides to offer BOD products. A BOD product may be a digital product that the merchant can define as a package (e.g., 5-pack, 10-pack, etc.) of existing products offered by the merchant in their product inventory, where a customer may pay for the BOD product as a single purchase price (e.g., a discounted price for a 10-pack as opposed to adding 10 individual quantities of the same item to cart and checking out). The BOD product also may provide the user the option to buy now and redeem later on-demand. That is, depending on the product settings configured by the merchant, the user may bulk quantities of an item as a BOD product offered by the merchant and then redeem them one or more quantities at a time as and when the user chooses to do so.

In the series 200A, the application operator 120 may create 202 a BOD seller account with the BOD platform 110. For example, the merchant may download and install the BOD merchant application 144 on their device 140N and interact with the user interface of the application 144 to create a new merchant account on the BOD platform 110.

The merchant may configure 204 settings to establish a connection between the BOD platform 110 and the merchant's account on the application builder platform 130. For example, the merchant may provide access delegation by creating an oAuth connection 206 to delegate the BOD platform 110 access to the account information of the merchant or application operator 120 on the application builder platform 130 without sharing the authentication information of the application operator 120 for accessing their account on the application builder platform 130. In one or more embodiments, the application operator 120 may also provide authorization and credentials to the BOD platform 110 for the BOD platform 110 to subscribe to one or more API notification channels (e.g., new orders channel) provided by the application builder platform 130. To establish the oAuth connection 206, the application builder platform 130 may provide a token (e.g., API key, secure key) 208 to the merchant that may be saved by the merchant into their BOD platform 110 account. The BOD platform 110 may use the key to interact with the application builder platform 130 on behalf of the application operator 120. By subscribing to application programming interface (API) notification channels of the backend 130 with the secure token of the operator 120, the platform 110 eliminates the need for merchant operators 120 to poll the e-commerce backend 130 and thus reduces network traffic and latency.

The BOD platform 110 also stores order events and redemption events in association with a persistent vault of each user. The persistent vault may comprise a total purchased quantity, a remaining redeemable quantity, and a redemption history. The redemption history may record each redemption event, including the product variant selected, the quantity redeemed, and the date/time of redemption. This data structure may allow the BOD platform 110 to verify redemption constraints, reconcile inventory, and provide an accurate account of purchases and redemptions across multiple sessions and across multiple merchants.

To offer BOD products to consumers, the merchant operating the computing device 140N may interact with the application builder platform 130 to create 210 a BOD product as part of their product catalog in their online storefront. For example, the merchant may design a product detail page describing the BOD product, including the product description, the price, available quantity, and other information regarding the product. The application builder platform 130 may assign, e.g., a unique product identifier to the BOD product added to the inventory and being offered to customers via the online storefront.

In the series 200A, the merchant may create a BOD definition object 212. The BOD definition object enables the merchant to define a set of fulfillable products and related quantity to be added to the consumer's fulfillable products on hand when a given BOD product is sold via the application builder platform 130. Fulfillable products on hand refer to the quantity of fulfillable products that the customer is entitled to based on the BOD products they have purchased and the related definition of those products at the time of purchase.

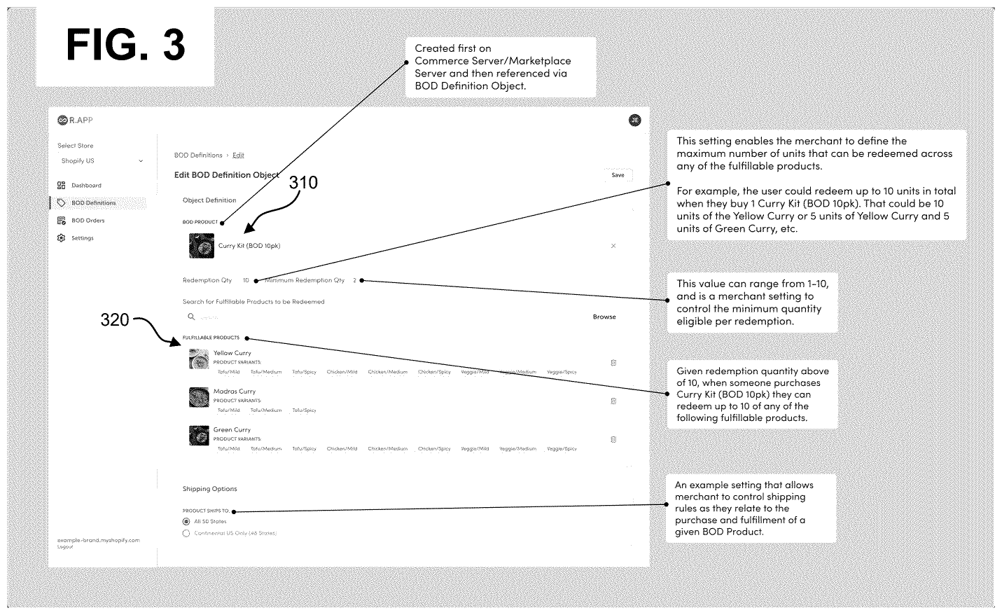

FIG. 3 is an example illustration of graphical user interface provided by the BOD merchant application 144 of the BOD platform 110 for the merchant to compose the BOD definition object, in accordance with one or more embodiments. The BOD object definition allows the merchant to specify a BOD product 310 that they have created on the marketplace (e.g., the application builder platform 130). For example, the merchant may select the BOD product 310 from a dropdown list of products listed in the merchant's marketplace product catalog. At the backend, the BOD merchant application 144 may receive product catalog data associated with the merchant from the merchant's account on the application builder platform 130. In the example shown in FIG. 3, the BOD product 310 is a curry kit (10-pack). The merchant may further specify the redemption quantity (e.g., redemption quantity is 10 in the example), and a minimum redemption quantity (e.g., minimum redemption quantity of 2 in the example).

The merchant may further select one or more products from their online product catalog as fulfillable products 320 that can be selected by consumers when a particular consumer is redeeming their BOD product. For example, the merchant may select one or more fulfillable products and their variants 320 from a dropdown list of products and variants listed in the merchant's marketplace product catalog hosted by the application builder platform 130. In the example shown in FIG. 3, the fulfillable products 320 can be any of several variants of Yellow Curry, any of several variants of Madras Curry, or any of several listed variants of the Green Curry. The consumer who has bought the BOD product of FIG. 3 is thus able to redeem up to 10 packs of any of the different fulfillable product variants 320 configured by the merchant. As a result, products can be sold in bulk and product variants can be abstracted at the time of purchase. The user may then decide when redeeming individual quantities which specific variant they wish to buy. Returning to FIG. 2A, the merchant creating and saving the BOD definition object at 212 completes the setup process for a BOD product. In some embodiments, the BOD definition object may specify one or more permitted variant combinations that define which combinations of product variants may be redeemed together. For example, a merchant may limit redemption of certain variants to specific ratios or sets, ensuring that the overall composition of redeemed items meets configuration requirements and inventory constraints.

Next, a user of the computing device 140A may interact with the application 142 of the application operator 120 to shop on the retailer's online storefront. For example, the user may purchase 214 the BOD product created at 210 and whose BOD definition object is created at 212. The user may purchase the product by completing a checkout process on the application builder platform 130. Since the BOD platform 110 has subscribed to an API notification channel for new orders of the application builder platform 130, the BOD product purchase at 214 triggers the application builder platform 130 to send 216 a notification to the BOD platform 110 with order data (e.g., API payload). For example, the application builder platform 130 may transmit (or send) data associated with the new order via a webhook. The order data may include a product identifier identifying the BOD product, and information regarding the customer (e.g., name, email, shipping addresses, and the like).

The BOD platform 110 listening to new orders received from the application builder platform 130 evaluates 218 the order contents to identify orders that match BOD definition objects. For example, since the product identifier received by the BOD platform at 216 matches a BOD product, e.g., 310, whose definition was created at 212, the evaluation 218 results in a match for a BOD product. Upon identifying a BOD product, the BOD platform extracts the customer identifier included in the API payload and consults an account-mapping data structure that associates customer identifiers issued by the application builder platform 130 with user identifiers used by the BOD platform 110. If the mapping table contains an entry for the received customer identifier, the platform 110 retrieves the corresponding user identifier and thereby determines that the customer is an existing user of the BOD platform 110. If no mapping exists, the BOD platform 110 creates a new user account record, assigns a new user identifier, stores an association between the received customer identifier and the newly assigned user identifier, and generates a notification inviting the customer to download the BOD user application and complete their account setup.

If the customer identifier maps to an existing user identifier, the BOD platform 110 will add the purchased BOD product, e.g., 310, to the online vault of that user and increment 220 the shopper's fulfillable products on hand according to the BOD definition object. If the order contents of the new order received at 218 do not match any BOD definition object for the application operator 120, this means that the new order is not a BOD product (i.e., it is a conventional fulfillable order that will be fulfilled by the application builder platform 130 or the fulfillment operator 150). In this case, the BOD platform 110 may simply ignore the webhook and keep listening for more orders until an order for a BOD product is received.

If the order is a BOD product and the account-mapping data structure does not contain an entry for the received customer identifier, i.e., the shopper does not yet have a user identifier on the BOD platform, the platform 110 may generate and transmit a notification (e.g., email, SMS message) to the user to prompt the user to open or complete a new account with the BOD platform 110 so they can access their BOD product purchase and redeem selected quantities of the BOD product. For example, the platform 110 may prompt the user to download and install the BOD user application 143 so they can access and redeem their BOD products, identify redemption quantities, identify product variants for redemption, update shipping addresses, and the like. The account-mapping data structure (used to match external customer identifiers managed by e-commerce platform 130 with internal user identifiers managed by the BOD platform 110) may enable cross-platform user management and prevent duplicate accounts, ensuring seamless integration across merchants.

After the BOD product has been added to the user's online vault and the fulfillable products on hand has been incremented, the BOD platform 110 notifies 222 the user of the available products and product quantities in their vault. For example, the platform 110 transmits a push notification to the user's device 140A and presents the user's online vault incremented with the fulfillable products on hand for the BOD product in the BOD user application 143. After the BOD platform 110 has incremented a user's vault, it may automatically generate and transmit a notification to the user's computing device, such as a push notification, email, or SMS message. The notification may display the updated remaining redeemable quantity and lists the available fulfillable product variants that the user may select for redemption. The BOD user application 143 may present a unified vault interface showing, for each BOD product purchased from any merchant, the total quantity purchased, the remaining quantity, the redemption history, and the available product variants. This unified vault may allow users to manage all of their BOD products across multiple merchants through a single interface. That is, the BOD platform 110 may provide a unified vault interface that aggregates fulfillable product balances and redemption histories for each user across multiple merchants. Instead of requiring the user to log into separate merchant systems, the platform 110 may maintain a single, stateful view of all BOD products purchased from different application operators 120. This unified view may be continuously synchronized across distributed systems, the e-commerce backend 130, the BOD platform 110, and any fulfillment operators 150, so that updates to one merchant's vault are reflected in the user's overall balance. By maintaining a persistent state and presenting it through one interface, the platform 110 reduces friction for the end user, simplifies redemption workflows, and provides a concrete technical improvement over conventional siloed systems.

Next in the series 200A, the user may interact 224 with the application 143 to redeem one or more quantities of the fulfillable products on hand for the BOD product in their online vault. For each redeemed quantity, the user may specify the product variant out of the fulfillable products based on the BOD product definition and complete the checkout process. In one or more embodiments, the user also may interact with the application 143 to provide one or more shipping addresses for the redeemed quantity. When the user submits a redemption request via the BOD user application 143, the request may also include a shipping address. The BOD platform 110 captures the shipping address and includes it in the structured fulfillment order object that is transmitted to the application builder platform 130 or to the transaction fulfillment operator 150. The structured order object may contain the product identifiers of the selected fulfillable product variants, the quantity redeemed, metadata indicating that the order corresponds to a pre-paid redemption, and the shipping address, thereby enabling the fulfillment system to deliver the redeemed items to the user.

In some embodiments, the BOD definition and the fulfillment order may be implemented as structured data objects that enable automated, cross-platform fulfillment. Each BOD definition object may be a data structure that consolidates the bulk product identifier, the permissible product variant identifiers, the total quantity purchased, the minimum redemption quantity, and any variant-combination rules. Collecting these fields in a single object may allow the platform 110 to treat a bulk purchase as a stateful resource while deferring the choice of variant until redemption. Likewise, each fulfillment order object may be a structured object that encapsulates the user-selected variant identifiers, the redeemed quantity, metadata indicating that the redemption has been pre-paid, and delivery details such as shipping address and timestamp. Because the BOD definition and fulfillment order objects explicitly encode the variant and redemption information, they can be serialized and transmitted between the merchant's e-commerce backend 130, the BOD system 110, and the fulfillment operator 150 without further interpretation, ensuring that variant selections and redemption constraints are preserved throughout the transaction. These data models may operate within an event-driven architecture: the platform 110 subscribes to order-creation webhooks using a secure token and processes each incoming order event as it occurs, and, as soon as a redemption request is validated, it generates and transmits the structured fulfillment order. By handling events asynchronously and avoiding batch polling or manual reconciliation, the platform 110 improves processing speed and reduces computational overhead, thereby enhancing the performance and reliability of the underlying e-commerce systems.

The application 143 may send 226 to the BOD platform 110 the information necessary to create the order on the application builder platform. For example, the information may include the product identifiers of the fulfillable products selected by the user for redemption and associated with the BOD product per the BOD definition object. The BOD platform 110 may allow the user to complete the checkout for the redeemed quantity on the application 143 if predetermined conditions are met. For example, the BOD platform 110 may check whether the redeemed quantity meets the minimum redemption quantity per the BOD definition object. The BOD platform 110 may further check whether the redeemed quantity is equal to or less than the fulfillable quantity on hand in the user's online vault. To validate a redemption request, the BOD platform 110 may compare the requested redemption quantity to the remaining redeemable quantity in the user's vault and verify that the selected product variants are among the permissible variants defined in the BOD definition object. The platform may also check whether the requested redemption quantity meets the minimum redemption quantity specified in the BOD definition object. If the requested quantity is less than the minimum redemption quantity, the platform may deny the redemption request or prompt the user to adjust the request to meet the minimum requirement.

The BOD platform 110 may update 228 the user's online vault to decrease (decrement) the quantity of the fulfillable products on hand based on the quantity redeemed in the current order. The BOD platform 110 may then send 230 a message (e.g., API notification) to the application builder platform 110 to fulfill the order. The message may include, e.g., the product identifiers of the fulfillable products, quantity, shipping information, and information indicating that this order is part of a BOD product redemption and that it has already been paid for by the user in advance. The application builder platform 130 may fulfill 232 the order received from the BOD platform 110, and the product is delivered to the user 234 of the computing device 140A.

FIG. 2B illustrates an example series 200B of interactions in which order fulfillment 250 of a BOD order redemption is performed by the transaction fulfillment operator 150. Other components and functionalities illustrated in FIG. 2B are the same as those illustrated in FIG. 2A and detailed description of the same is omitted here. In some embodiments, the BOD platform 110 may operate across multiple application operators 120. The persistent vault for each user may be unified across merchants, so that a user's vault may contain BOD products purchased from different application operators 120. The BOD user application 143 may then allow the user to view and redeem each BOD product separately while maintaining aggregated records and enforcing the appropriate redemption constraints for each product. The platform 110 may store the aggregated order and redemption events for each user, enabling cross-merchant reporting and analytics. Maintaining the persistent vault for each user across sessions and merchants may provide stateful synchronization that improves reliability and eliminates redundant storage, allowing the system to enforce redemption rules and reconcile orders automatically, without manual reconciliation.

### Example Method

FIG. 4 is a flowchart depicting an example process 400 for a bulk on demand platform to provide an interface for setup and redemption of a bulk on demand order, in accordance with one or more embodiments. Alternative embodiments may include more, fewer, or different steps from those illustrated in FIG. 4, and the steps may be performed in a different order from that illustrated in FIG. 4. These steps may be performed by a BOD platform (e.g., BOD platform 110). Additionally, each of these steps may be performed automatically by the online system without human intervention.

The BOD platform 110 may receive 410, via inputs through a graphical user interface (e.g., FIG. 3) and from an application operator (e.g., operator 120 operating device 140N), a configuration of a bulk on demand (BOD) definition object (e.g., FIG. 3), the BOD definition object defining a set of fulfillable products and related quantity to be added to a user's online vault when the user buys a given BOD product.

The BOD platform 110 may subscribe 420 to, on behalf of the application operator, an application programming interface (API) notification channel of an application builder platform (e.g., application builder platform 130), the application builder platform providing backend e-commerce functionality to the application operator and the API notification channel providing order data for new orders received by the application builder platform on behalf of the application operator. The BOD platform 110 may receive 430, via the API notification channel, order data of a new order (e.g., via a webhook).

The BOD platform 110 may parse 440 the order data to determine that the new order includes an identifier (e.g., product identifier used by the application builder platform 130 and provided to the BOD platform 110 when creating the BOD definition object) associated with the given BOD product. The BOD platform 110 may increment 450 a quantity of fulfillable products on hand in an online vault of a user and transmit a notification to the user indicating the incremented quantity.

The BOD platform 110 may receive 460 a redemption request from the user, the request including a redemption quantity and a selection of a fulfillable product variant for each quantity. For example, the user may interact with the BOD user application 143 on the computing device 140 to access their online vault and redeem some or all of the remaining fulfillable product quantity in the vault. For each redeemed quantity, the user may also specify the product variants such as size, color, flavor, etc. The BOD platform 110 may decrease 470 the quantity of fulfillable products on hand in the user's online vault by the redemption quantity. And the BOD platform 110 may transmit 480 a fulfillable order request on behalf of the user to the application builder platform 130, the request including for each redemption quantity, a fulfillable product identifier based on the BOD definition object.

### Computing Machine Architecture

FIG. 5 is a block diagram illustrating components of an example computing machine that is capable of reading instructions from a computer-readable medium and execute them in a processor (or controller). A computer described herein may include a single computing machine shown in FIG. 5, a virtual machine, a distributed computing system that includes multiples nodes of computing machines shown in FIG. 5, or any other suitable arrangement of computing devices.

By way of example, FIG. 5 shows a diagrammatic representation of a computing machine in the example form of a computer system 500 within which instructions 524 (e.g., software, source code, program code, bytecode, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 5 may correspond to any software, hardware, or combined components shown in FIGS. 1-4, including but not limited to, the BOD platform 110, the application builder platform 130, the user computing device 140, series 200A, series 200B, user interface 300, and method 400. The instructions may correspond to the functionality of components and interfaces described with FIGS. 1-4.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 524 that specify actions to be taken by that machine. Further, while only a single machine is illustrated, the term “machine” and “computer” may also be taken to include any collection of machines that individually or jointly execute instructions 1024 to perform any one or more of the methodologies discussed herein.

The example computer system 500 includes a processing system that may include one or more processors 502 such as a CPU (central processing unit), a GPU (graphics processing unit), a TPU (tensor processing unit), a DSP (digital signal processor), a system on a chip (SOC), a controller, a state machine, an application-specific integrated circuit (ASIC), a field-programmable gate array (FPGA), or any combination of these. Parts of the computing system 500 may also include a memory 504 that store computer code including instructions 524 that may cause the processors 502 to perform certain actions when the instructions are executed, directly or indirectly by the processors 502. Instructions can be any directions, commands, or orders that may be stored in different forms, such as equipment-readable instructions, programming instructions including source code, and other communication signals and orders. Instructions may be used in a general sense and are not limited to machine-readable codes.

One and more methods described herein improve the operation speed of the processors 502 and reduces the space required for the memory 504. The algorithms described herein also reduces the size of the models and datasets to reduce the storage space requirement for memory 504.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors. The computer system 500 may include a main memory 504, and a static memory 506, which are configured to communicate with each other via a bus 508. The computer system 500 may further include a graphics display unit 510 (e.g., a plasma display panel (PDP), a liquid crystal display (LCD), a projector, or a cathode ray tube (CRT)). The graphics display unit 510, controlled by the processors 502, displays a GUI (GUI) to display one or more results and data generated by the processes described herein. The computer system 500 may also include an alphanumeric input device 512 (e.g., a keyboard), a cursor control device 514 (e.g., a mouse, a trackball, a joystick, a motion sensor, or another pointing instrument), a storage unit 516 (a hard drive, a solid state drive, a hybrid drive, a memory disk, etc.), a signal generation device 518 (e.g., a speaker), and a network interface device 520, which also are configured to communicate via the bus 508.

The storage unit 516 includes a computer-readable medium 522 on which is stored instructions 524 embodying any one or more of the methodologies or functions described herein. The instructions 524 may also reside, completely or at least partially, within the main memory 504 or within the processor 502 (e.g., within a processor's cache memory) during execution thereof by the computer system 500, the main memory 504 and the processor 502 also constituting computer-readable media. The instructions 524 may be transmitted or received over a network 526 via the network interface device 520.

While computer-readable medium 522 is shown in an example embodiment to be a single medium, the term “computer-readable medium” should be taken to include a single medium or multiple media (e.g., a centralized or distributed database, or associated caches and servers) able to store instructions (e.g., instructions 524). The computer-readable medium may include any medium that is capable of storing instructions (e.g., instructions 524) for execution by the processors (e.g., processors 502) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

What is claimed is:

1. A system, comprising:
at least one memory; and
at least one processor coupled with the at least one memory, the at least one memory storing code comprising instructions that, when executed by the at least one processor, cause a bulk-on-demand platform to perform operations comprising:
presenting, via a user interface, a configuration workflow that receives from a merchant operator a bulk-on-demand (BOD) definition comprising: (i) a bulk product identifier corresponding to an item listed in a catalog of an e-commerce platform; (ii) product identifiers of one or more fulfillable product variants associated with the bulk product identifier; and (iii) redemption constraints specifying a total redeemable quantity, a minimum redemption quantity, and permitted variant combinations;
establishing, by the bulk-on-demand platform, a subscription to at least one application-programming-interface (API) notification channel of the e-commerce platform to receive order notifications on behalf of the merchant operator;
receiving, via the API notification channel, a plurality of order notifications, each comprising an API payload that includes a customer identifier of the e-commerce platform, a product identifier, and an order quantity, and for each received order notification: (i) identifying that the product identifier matches the bulk product identifier defined in the BOD definition; (ii) determining that the customer identifier of the e-commerce platform matches to a user account maintained by the bulk-on-demand platform; (iii) updating a persistent vault associated with the user account by incrementing a redeemable quantity in accordance with the order quantity; and (iv) storing an order event record associated with the user account;
maintaining, for each user account, the persistent vault comprising a total purchased quantity, a remaining redeemable quantity, and a redemption history, the persistent vault persisting across multiple user sessions and across multiple merchant storefronts;
receiving, from a user computing device via a customer-facing application of the bulk-on-demand platform, a redemption request comprising a user identifier of the user account maintained by the bulk-on-demand platform, a selection of one or more fulfillable product variants, and a requested redemption quantity;
validating that the requested redemption quantity does not exceed the remaining redeemable quantity recorded in the persistent vault and that the selected fulfillable product variants comply with the redemption constraints of the BOD definition, and in response to the validation:
updating the persistent vault by decrementing the remaining redeemable quantity according to the requested redemption quantity, and generating a structured fulfillment order object comprising the selected fulfillable product variants, the requested redemption quantity, and metadata indicating that the order corresponds to a pre-paid redemption; and
transmitting the structured fulfillment order object to the e-commerce platform for processing and fulfillment.

2. The system of claim 1, wherein the instructions that cause the bulk-on-demand platform to perform the operation of establishing the subscription to the at least one API notification channel comprise instructions that cause the bulk-on-demand platform to perform an operation comprising:
receiving an authorization token from the merchant operator, the authorization token enabling automatic receipt from the e-commerce platform of order events associated with the merchant operator including events related to the bulk product identifier.

3. The system of claim 1, wherein the bulk-on-demand platform stores order events and redemption events in association with the persistent vault corresponding to the user identifier.

4. The system of claim 1, wherein the e-commerce platform is operable as a backend component of an e-commerce application controlled by the merchant operator.

5. The system of claim 1, wherein the instructions that cause the bulk-on-demand platform to perform the operation of updating the persistent vault further comprise instructions that cause the bulk-on-demand platform to perform an operation comprising:
transmitting, to the user computing device associated with the user identifier, a notification indicating an updated quantity of fulfillable products on hand in the persistent vault and presenting available fulfillable product variants for redemption.

6. The system of claim 1, wherein the instructions that cause the bulk-on-demand platform to perform the operation of receiving the redemption request further comprise instructions that cause the bulk-on-demand platform to perform an operation comprising:
receiving, via the customer-facing application, a shipping address for the requested redemption quantity and to include the shipping address in the structured fulfillment order object.

7. The system of claim 1, wherein the instructions that cause the bulk-on-demand platform to perform the operation of validating the requested redemption quantity further comprise instructions that cause the bulk-on-demand platform to perform an operation comprising:
determining whether the requested redemption quantity meets the minimum redemption quantity, and, in response to determining that it does not, to deny the redemption request or prompt the user computing device to adjust the requested redemption quantity.

8. The system of claim 1, further comprising instructions that cause the bulk-on-demand platform to perform an operation comprising:
presenting, via the customer-facing application, a unified vault interface that aggregates fulfillable products purchased by the user account from multiple merchant operators and allows a user to view remaining fulfillable quantities and redeem quantities of those products through a single interface.

9. A computer-implemented method comprising:
presenting, via a user interface, a configuration workflow that receives from a merchant operator a bulk-on-demand (BOD) definition comprising: (i) a bulk product identifier corresponding to an item listed in a catalog of an e-commerce platform; (ii) product identifiers of one or more fulfillable product variants associated with the bulk product identifier; and (iii) redemption constraints specifying a total redeemable quantity, a minimum redemption quantity, and permitted variant combinations;
establishing, by a bulk-on-demand platform, a subscription to at least one application-programming-interface (API) notification channel of the e-commerce platform to receive order notifications on behalf of the merchant operator;
receiving, via the API notification channel, a plurality of order notifications, each comprising an API payload that includes a customer identifier of the e-commerce platform, a product identifier, and an order quantity, and for each received order notification: (i) identifying that the product identifier matches the bulk product identifier defined in the BOD definition; (ii) determining that the customer identifier of the e-commerce platform matches to a user account maintained by the bulk-on-demand platform; (iii) updating a persistent vault associated with the user account by incrementing a redeemable quantity in accordance with the order quantity; and (iv) storing an order event record associated with the user account;
maintaining, for each user account, the persistent vault comprising a total purchased quantity, a remaining redeemable quantity, and a redemption history, the persistent vault persisting across multiple user sessions and across multiple merchant storefronts;
receiving, from a user computing device via a customer-facing application of the bulk-on-demand platform, a redemption request comprising a user identifier of the user account maintained by the bulk-on-demand platform, a selection of one or more fulfillable product variants, and a requested redemption quantity;
validating that the requested redemption quantity does not exceed the remaining redeemable quantity recorded in the persistent vault and that the selected fulfillable product variants comply with the redemption constraints of the BOD definition, and in response to the validation:
updating the persistent vault by decrementing the remaining redeemable quantity according to the requested redemption quantity, and generating a structured fulfillment order object comprising the selected fulfillable product variants, the requested redemption quantity, and metadata indicating that the order corresponds to a pre-paid redemption; and
transmitting the structured fulfillment order object to the e-commerce platform for processing and fulfillment.

10. The method of claim 9, further comprising:
receiving an authorization token from the merchant operator, the authorization token enabling automatic receipt from the e-commerce platform of order events associated with the merchant operator including events related to the bulk product identifier.

11. The method of claim 9, wherein the bulk-on-demand platform stores order events and redemption events in association with the persistent vault corresponding to the user identifier.

12. The method of claim 9, wherein the e-commerce platform is operable as a backend component of an e-commerce application controlled by the merchant operator.

13. The method of claim 9, further comprising:
transmitting, to the user computing device associated with the user identifier, a notification indicating an updated quantity of fulfillable products on hand in the persistent vault and presenting available fulfillable product variants for redemption.

14. The method of claim 9, further comprising:
receiving, via the customer-facing application, a shipping address for the requested redemption quantity and to include the shipping address in the structured fulfillment order object.

15. The method of claim 9, further comprising:
determining whether the requested redemption quantity meets the minimum redemption quantity, and, in response to determining that it does not, to deny the redemption request or prompt the user computing device to adjust the requested redemption quantity.

16. The method of claim 9, further comprising:
presenting, via the customer-facing application, a unified vault interface that aggregates fulfillable products purchased by the user account from multiple merchant operators and allows a user to view remaining fulfillable quantities and redeem quantities of those products through a single interface.

17. A non-transitory computer-readable storage medium comprising stored instructions that, when executed by one or more processors, cause a bulk-on-demand platform to:
present, via a user interface, a configuration workflow that receives from a merchant operator a bulk-on-demand (BOD) definition comprising: (i) a bulk product identifier corresponding to an item listed in a catalog of an e-commerce platform; (ii) product identifiers of one or more fulfillable product variants associated with the bulk product identifier; and (iii) redemption constraints specifying a total redeemable quantity, a minimum redemption quantity, and permitted variant combinations;
establish, by the bulk-on-demand platform, a subscription to at least one application-programming-interface (API) notification channel of the e-commerce platform to receive order notifications on behalf of the merchant operator;
receive, via the API notification channel, a plurality of order notifications, each comprising an API payload that includes a customer identifier of the e-commerce platform, a product identifier, and an order quantity, and for each received order notification: (i) identifying that the product identifier matches the bulk product identifier defined in the BOD definition; (ii) determining that the customer identifier of the e-commerce platform matches to a user account maintained by the bulk-on-demand platform; (iii) updating a persistent vault associated with the user account by incrementing a redeemable quantity in accordance with the order quantity; and (iv) storing an order event record associated with the user account;
maintain, for each user account, the persistent vault comprising a total purchased quantity, a remaining redeemable quantity, and a redemption history, the persistent vault persisting across multiple user sessions and across multiple merchant storefronts;
receive, from a user computing device via a customer-facing application of the bulk-on-demand platform, a redemption request comprising a user identifier of the user account maintained by the bulk-on-demand platform, a selection of one or more fulfillable product variants, and a requested redemption quantity;
validate that the requested redemption quantity does not exceed the remaining redeemable quantity recorded in the persistent vault and that the selected fulfillable product variants comply with the redemption constraints of the BOD definition, and in response to the validation:
update the persistent vault by decrementing the remaining redeemable quantity according to the requested redemption quantity, and generating a structured fulfillment order object comprising the selected fulfillable product variants, the requested redemption quantity, and metadata indicating that the order corresponds to a pre-paid redemption; and
transmit the structured fulfillment order object to the e-commerce platform for processing and fulfillment.

18. The non-transitory computer-readable storage medium of claim 17, wherein the instructions further comprise instructions that, when executed, cause the bulk-on-demand platform to:
receive an authorization token from the merchant operator, the authorization token enabling automatic receipt from the e-commerce platform of order events associated with the merchant operator including events related to the bulk product identifier.

19. The non-transitory computer-readable storage medium of claim 17, wherein the bulk-on-demand platform stores order events and redemption events in association with the persistent vault corresponding to the user identifier.

20. The non-transitory computer-readable storage medium of claim 17, wherein the e-commerce platform is operable as a backend component of an e-commerce application controlled by the merchant operator.
